(19) United States
(12) Patent Application Publication
(10) Pub. No.: US 2024/0116078 A1
(43) Pub. Date: Apr. 11, 2024

(54) ROTATIONAL DIPPING OF STORAGE DISK MEDIA

(71) Applicant: Western Digital Technologies, Inc., San Jose, CA (US)

(72) Inventors: Qi Sun, San Jose, CA (US); David W. Oswald, Morgan Hill, CA (US); Robert M. Tierney, Fremont, CA (US)

(21) Appl. No.: 18/365,955

(22) Filed: Aug. 4, 2023

Related U.S. Application Data
(60) Provisional application No. 63/413,956, filed on Oct. 6, 2022.

(51) Int. Cl. B05D 5/08; B05C 3/09; B05C 13/02; B05D 1/18

(52) U.S. Cl. CPC B05D 5/08; B05C 3/09; B05C 13/025; B05D 1/18

(57) ABSTRACT

Devices and methods are disclosed for a lubricant station for applying lubricant to storage disk platters. The lubricant station includes a tub for holding lubricant and a caddy disposed in the tub, with the storage disk platters placed in the caddy. The caddy includes a mandrel configured to raise and lower the storage disk platters into the tub. The caddy also includes rotatable shafts configured to hold the storage disk platter. The caddy also includes a drive mechanism for rotating the rotatable shafts. The lubricant station also includes control circuitry configured to lower the storage disk platters onto the rotatable shafts of the caddy, rotate the rotatable shafts and the storage disk platters, and remove the storage disk platters from the tub.

### CROSS-REFERENCE TO RELATED APPLICATIONS

The present application claims priority to U.S. Provisional Patent Application Ser. No. 63/413,956, filed Oct. 6, 2022, entitled ROTATIONAL DIPPING OF STORAGE DISK MEDIA, the disclosure of which is hereby incorporated by reference in its entirety.

### BACKGROUND

### Field

This disclosure relates to the manufacturing of data storage devices. More particularly, the disclosure relates to devices and methods for applying lubricant to storage disk media.

### Description of Related Art

Hard disk drives (HDD) utilize magnetic disk media for data storage. The disk media is rotated during reading and writing data to the disk. To protect the moving disk media, lubricant is applied to the disk media during manufacturing.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIG. 1 illustrates a block diagram for a lubricant station used during manufacturing of disk platters, in accordance with some embodiments.

FIGS. 2 and 3 illustrate, respectively, a front perspective view and a rear perspective view of a disk caddy of the lubricant station, in accordance with some embodiments.

FIGS. 4 and 5 are, respectively, bottom and side views of the disk caddy, in accordance with some embodiments.

FIG. 6 illustrates a process for dipping storage media into a lubricant bath, in accordance with some embodiments.

### DETAILED DESCRIPTION

While certain embodiments are described, these embodiments are presented by way of example only, and are not intended to limit the scope of protection. Indeed, the novel methods and devices described herein may be embodied in a variety of other forms. Furthermore, various omissions, substitutions and changes in the form of the methods and devices described herein may be made without departing from the scope of protection.

### Overview

Hard disk drives (HDD) utilizes magnetic disk media to store data. Typically, each magnetic disk has a protective layer and a lubricating layer on a magnetic recording layer formed over a substrate, for the purpose of ensuring the durability and reliability of the magnetic disk. Particularly, the lubricating layer used at the outermost surface can have various properties such as long-term stability, chemical substance resistance, friction properties, and/or heat resistance.

During read/write operations, a magnetic head flies close (e.g., 10 nm or less) to the magnetic disk. The magnetic head can repeatedly exert compression and expansion on a lubricating layer on the surface of a magnetic disk through air molecules while flying, so that the lubricating layer tends to be repeatedly subjected to heating and cooling. If the molecular weight of the lubricant is reduced, its fluidity increases so that its adhesion to a protective layer decreases, allowing the lubricant to more easily be transferred and deposited on the magnetic head. As the head is located extremely close to the surface of the media, variability in the thickness of the lubricant on the disk media can place some of the lubricant closer to the head, making a fly stiction failure more likely, when some the lubricant gets on the head.

Particularly, a magnetic head with a negative pressure slider may lead to more transfer deposition of lubricant because it tends to suck the lubricant due to a strong vacuum created at the bottom surface of the magnetic head. In addition, variable thickness of the lubricant on the media can make the lubricant more prone to smearing. Thus, there is a benefit in applying a more uniform layer of lubricant with limited high points of lubricant on the media, lowering the chance of the head touching these high points and producing a read/write failure.

Disclosed herein are devices and methods for applying lubricant more uniformly to disk media. Typically, media is dipped vertically into a lubricant bath. This vertical dipping process tends to result in a thickness difference in the lube, as the bottom of the disk media contacts the lubricant solvent (also called process fluid or lubricant bath) first and top of the disk media contacts the lubricant solvent last, with up to several seconds of difference in the dwell time in the bath. Different parts of the media are immersed in the bath for different amounts of times, with the portions (e.g., bottom of disk) that are immersed longer having more lubricant bonded due to the longer dwell time in the lubricant bath, while the portions (e.g., top of disk) that are immersed for a shorter duration have less lubricant bonded to them due to the shorter dwell time in the lubricant bath.

### Lubricant Station

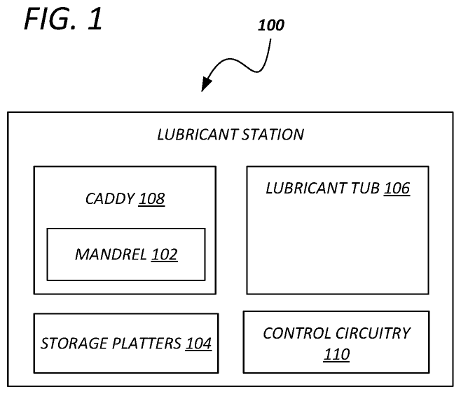

FIG. 1 illustrates a block diagram for a lubricant station 100 used during manufacturing of disk platters, in accordance with some embodiments. The lubricant station 100 can include a caddy 108 having a mandrel 102 or other lifting mechanism for carrying and moving disk media, also called storage disk platters or storage platters 104, to different locations at the lubricant station. In one example, the mandrel 102 extends through a central hole found in each storage platter 104. The lubricant station 100 can include a lubricant tub 106 for holding lubricant. The caddy 108 can be positioned within the lubricant tub 106. A portion of the caddy 108 (e.g., a drive mechanism) may extend through a wall of the lubricant tub 106 to the outside of the tub. The mandrel 102 can raise or lower the storage platters 104 into the caddy 108, submerging the storage platters 104 in the lubricant inside the lubricant tub 106. The lubricant station 100 can include control circuitry 110, such as a computer workstation or specialized controller, for controlling the mandrel 102 and/or the rotational movement of the caddy 108.

The control circuitry 110 of the lubricant station 100 can include one or more central processing units (CPUs), controllers, memory, input/output interfaces, and/or the like. The control circuitry may be configured to execute certain software applications, drivers, or firmware for implementing the functionality described herein.

The storage platters 104 are physical media for a hard disk drive (HDD). Data is magnetically stored on the storage platters 104. Disk platters are rigid, thin circles that spin under the power of a drive spindle motor. The platters have a central hole 132, such that stacks of platters can be placed around the drive spindle motor and connected to it via a spindle surrounding the drive spindle motor. Typically, the disk platters have three layers: a substrate, a magnetic layer, and a protective overcoat layer. The substrate give the platter its rigid form. Platters are typically made using an aluminum, glass or ceramic substrate. The magnetic layer is where data is stored. Typically, the magnetic layer is a thin coating deposited on both sides of the substrate, by using, for example, a vacuum deposition process called magnetron sputtering. The protective layer helps minimize damage to the disk drive from particles such as dust. Typically, the protective layer is a carbon-based overcoat that is deposited using the same sputtering process as the magnetic layer.

In post-processing of the platter, a (typically) nanometer thin polymeric lubricant layer gets deposited on top of the sputtered structure by dipping the disk into a solvent solution. The solvent structure can contain a lubricant, such as Perfluoropolyethers (PFPE). The lubricant can help reduce head-to-platter contact friction. Other types of lubricant may also be used. The platter is then buffed to eliminate small defects and then verified to be free of asperities or other defects, though a small number of defects may be acceptable.

### Rotational Disk Caddy

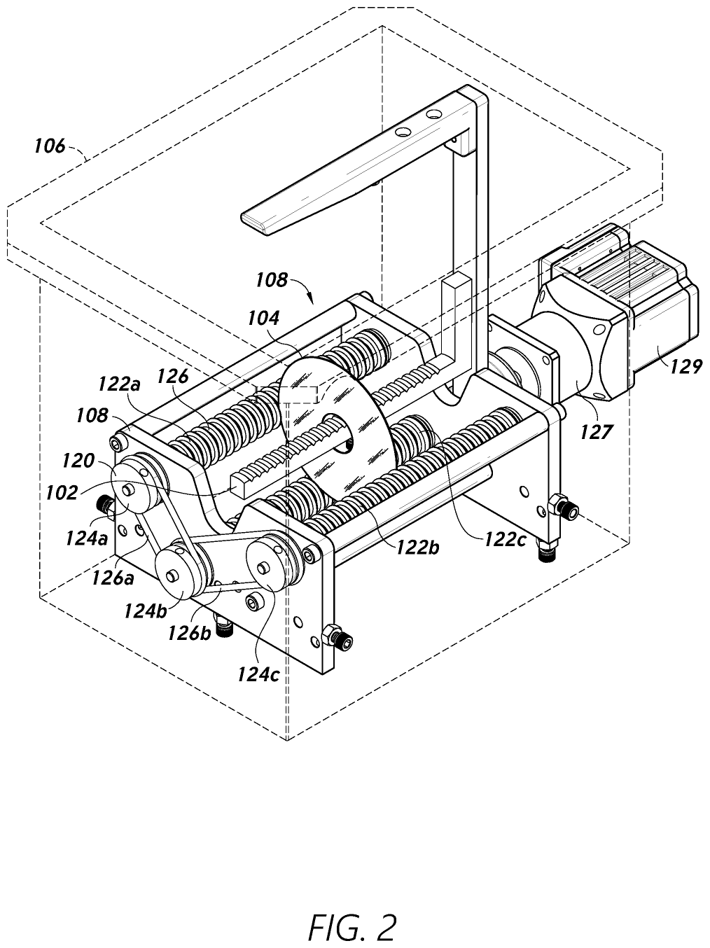

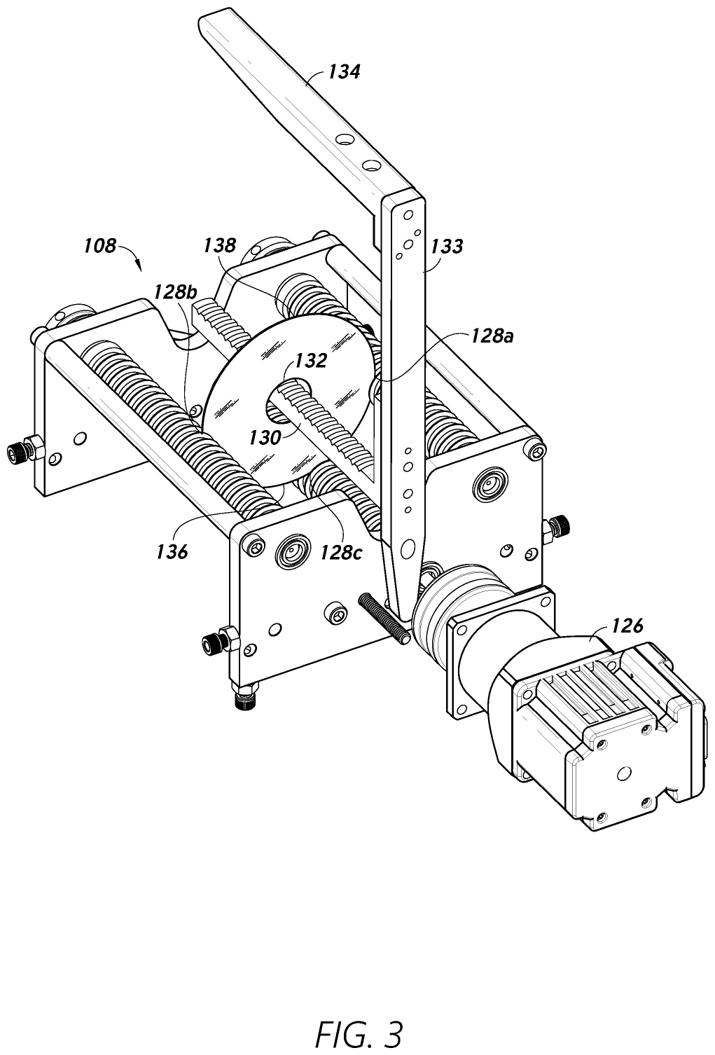

FIGS. 2 and 3 illustrate, respectively, a front perspective view and a rear perspective view of the disk caddy 108, in accordance with some embodiments. The disk caddy 108 can be placed in the lubricant tub 106, submerged in a process fluid containing lubricant. The disk caddy 108 is capable of holding and rotating a set of storage platters 104 that are placed within the caddy. By rotating the storage platters 104 on the caddy 108 before the storage platters 104 are removed from the lubricant tub 106, each section of a storage platter 104 dwells in lubricant tub 106 and the process fluid contained within at roughly the same amount of time.

In some examples, the disk caddy 108 may rotate the storage platters 104 outside of the lubricant tub 106. For example, the disk caddy 108 may include extendable legs (not shown) that allow the disk caddy 108 to lower and rise from the lubricant tub 106. The disk caddy 108 may lower itself into the lubricant tub 106, coating the storage platters 104 in the process fluid. The disk caddy 108 may then, using its extendable legs, rise out of the lubricant tub. The storage platters 104 on the disk caddy 108 may then be rotated while outside the lubricant tub. The disk caddy 108 may then again be lowered into the process fluid in the lubricant tub a second time.

Storage platter(s) 104 are placed on the mandrel 102 of the caddy 108. The storage platters 104 are typically a disk with a central hole 132, having an outer rim and an inner rim surrounding the central hole. The mandrel 102 fits through the central hole 132 of a storage platter, in contact with the inner rim of the platter. For ease of illustration, FIGS. 2-5 shows a single storage platter 104. However, typically multiple platters 104 are processed together for efficiency. During the lubrication process, the mandrel 102 holding the storage platters 104 is dipped into the lubricant tub 106. The storage platters 104 are then placed in the disk caddy 108. After the storage platters 104 contact the disk caddy 108, the mandrel 102 may lower slightly further so that the mandrel 102 is no longer in contact with interior rim of the storage platter 104. As can be seen in FIGS. 2 and 3, the mandrel 102 is not in contact with the interior rim of the illustrated storage platter 104. By removing contact, the storage platters 104 may be more easily rotated, since the point of contact(s) with the mandrel 102 are removed.

Upon first dipping the disk media, the first part of the disk media located at the top of the caddy is in the bath for 0 amount of time, with the second part of the disk media on the bottom of the caddy staying in the bath for Y amount of time (where Y is the time taken for the disk media to fully submerge in the bath). By rotating the disk media 180 degrees while in the bath, the first part becomes located at the bottom of the caddy and the top part becomes located at the top of the caddy. The disk media then stays in the bath for X amount of time, where X is the time it takes for the lubricant to bond to the disk media for the desired thickness. When removing the caddy from the bath (assuming the time to withdraw the disk media from the bath is also Y; that is the dipping speed and withdrawal speed of the caddy are the same), the second part is removed first and thus stays a total amount of X+Y time. Meanwhile the first part of the media stays an additional Y time as it is located on the bottom of the caddy, for a total time of X+Y. Thus, by rotating the disk media, the average time that each part of the disk media spends in the lubricant tub 106 is roughly the same (X+Y). There may be slight variations in time depending on if there is a difference between the dipping and rising speed for the caddy 108, or other mechanical variations in the caddy operation.

The caddy 108 can include a rotation mechanism 120. This mechanism can take various forms to hold the storage platters 104 and provide the rotational movement to the storage platters. In FIG. 2, the illustrated embodiment utilizes three rotatable shafts 122a, 122b, 122c (collectively referred to as “rotatable shafts 122”), with grooves 125 formed on the surface of the shafts. In one embodiment, each individual groove is aligned with the corresponding grooves formed on the three rotatable shafts. Disk media, when placed in each set of three corresponding grooves, are retained in a vertical position with three points of contact, with one contact point on each rotatable shaft.

As the rotatable shafts 122 are rotated, the storage platters 104 in each groove can be rotated the desired amount. For example, the disk media may be rotated 180 degrees, or 180+360*n degrees, where n is a whole number corresponding to the desired number of revolutions. Some possibilities for the disk rotation include 180 degrees, 540 degrees, 900 degrees, etc. The amount of rotation may include some variance in the number of degrees of rotation. For example, rather than exactly 180 degrees, the rotation may be about 180 degrees, with a±of 30 degrees (e.g., 150-210 degrees). Similarly, the rotations may also be about 180+360*n degrees, with a±of 30 degrees (e.g., 510-570 degrees, 870-930 degrees, etc.).

In some situations, additional revolutions of the disk media may promote more even bonding of the lubricant. For example, some portions of the lubricant may be more concentrated in some locations in the bath. Additional revolutions of the disk media can cause the different surfaces of the disk media to be exposed to different locations with different lubricant concentrations in the bath, ameliorating for variations in lubricant fluidity. While the above has discussed specific degrees of rotations, it will be apparent that any arbitrary degrees of rotation could be programmed into the dipping station as desired.

In one example, a first platter of the storage platters 104 comprises a first edge 136 and a second edge 138 (as shown in FIG. 3) opposite the first edge. The first edge enters the lubricant first. When placed in the caddy 108, the first edge ends up as the portion of the first platter at the lowest position in the lubricant tub 106. Meanwhile, the second edge 138 ends up as the portion of the first platter at the highest position in the lubricant tub 106. FIG. 3 illustrates the position of the first edge 136 and the second edge 138 upon the first platter being placed in the caddy 108, prior to rotation. The rotation mechanism 120 then causes the first edge 136 to rotate to a different position. Likewise, the second edge 138 begins in the highest position when the first platter enters the lubricant and touches the lubricant last. The second edge is then rotated to the previous position (e.g., lowest position) of the first edge 136. Due to the rotation, the first edge 136 and the second edge 138 switch places, with the first edge 136 ending up at the highest position and the second edge 138 ending up at the lowest position. As a result, when the first platter is lifted from the lubricant, the first edge, now at the highest position, leaves the lubricant first. Meanwhile, the second edge, now at the lowest position, leaves the lubricant last.

In another example, the first platter of the storage platters 104 comprises a first edge 136 and a second edge 138 opposite the first edge. Assuming the first platter is in a vertical orientation relative to the caddy 108, the first edge is positioned at a lowest point (the location 136 shown in FIG. 3) of the first platter in the vertical orientation while the second edge is positioned at a top point (the location 138 shown in FIG. 3) of the first platter in the vertical orientation. FIG. 3 illustrates the position of the first edge 136 and the second edge 138 upon the first platter being placed in the caddy 108, prior to rotation. The position of the first edge and the second edge are reversed after the first platter is lowered into the lubricant, but before the first platter is removed from the lubricant.

While the above has described using three rotatable shafts 122, other embodiments may use a different number of rotatable shafts. For example, other embodiments of the caddy 108 may use two rotatable shafts. If two shafts are spaced apart at a distance that is less than the maximum width of a storage platter, then a storage platter placed between the two rotatable shafts can be retained by the two rotating shafts. Other variations are also possible, such as having four or even more rotatable shafts.

It may also be possible to have a single rotatable shaft. For example, the mandrel 102 may itself be a rotatable shaft. After lowering the storage platters 104 into the lubricant, the rotatable mandrel 102 may provide rotation to the storage platters 104 itself, rather than relying on other rotatable shafts.

In another example, there may be a single rotatable shaft that works in tandem with the mandrel 102 to rotate the storage platters 104. For example, the single rotatable shaft may be positioned below the mandrel 102. The mandrel 102 can then lower the storage platters until the storage platters 104 are pinched between the single mandrel and the rotatable shaft, creating two points of contact. One of the mandrel 102 or the rotatable shaft may then impart rotational force on the storage platters 104 to turn the storage platters 104 the desired amount. While the above has discussed variations that use different numbers of points of contact, the use of at least three rotatable shafts provides at least three points of contact, which adds additional stability to the storage platters 104 as they are rotated.

In some embodiments, the drive mechanism 127 for the rotatable shafts uses a motor 129 and a belt drive or similar system. The motor can be connected to one of the rotatable shafts, such as the bottom rotatable shaft 122c. The motor can drive the bottom rotatable shaft 122c directly. One the other end of the rotatable shaft 122c, away from the motor, each of the rotatable shafts can end in a pulley 124a, 124b, 124c. The three pulleys can be connected to each other through belts 126a, 126b, chains, gears or other similar mechanisms. By turning the bottom rotatable shaft 122c, the rotational force is then transferred, through the pulleys, to the other rotatable shafts 122a, 122b through the belts 126a, 126b.

In addition, by connecting the three rotatable shafts 122a, 122b, 122c together through the belts, the shafts are able to rotate at the same speed so that the same amount of rotational force is applied to the disk media via its contact points 128a, 128b, 128c (shown in FIG. 3). This can provide a more consistent movement to the disk media, promoting more consistent results in terms of amount of lubricant deposited on the disk media.

Any of various types of belts and pulleys can be used to move the rotatable shafts. For example, the belts may be flat belts, round belts, spring belts, V-belts, multi-groove belts, toothed belts, ribbed belts, or the like. The surface of the pulleys can be designed to match the type of belt, such as by having grooves, tooths, a flat surface, ribbed, or the like, so as better engage with the surface of the belt. A motor can be connected to the shafts to directly drive one of the shafts, while indirectly driving the other shafts through the belts and pulleys. In other examples, not all the shafts need to be powered. For example, one of the shafts may be rotatable but not driven by the drive mechanism. When the other powered shaft(s) rotate the storage platters 104, the unpowered shaft may be rotated in turn by the storage platter, which can act similar to a gear.

Other types of drive mechanisms can also be used to drive the rotatable shafts. For example, each of the shafts may be directly driven by a motor, while the motors may be synchronized to turn the shafts at the same rate. In another example, the shafts may be connected via gears, with one of the shafts driven by a motor.

The storage platter(s) 104 can be placed and removed from the caddy by a lifting mechanism, such as the mandrel 102. The mandrel can include slots, ridges, or other mechanism to space apart the storage platters 104. For example, the edges of the mandrel may be raised relative to its center surface. The raised edges can provide more secure contact points for the storage platters 104 to. For example, valleys formed by the ridges can provide contact points for the storage platters, with each storage platter retained in place at two points of contact, at a first valley at the left ridged edge and a second valley at the second ridged edge.

In some embodiments, the mandrel 102 extends horizontally from a vertical shaft 133. The mandrel 102 can be movably attached to the vertical shaft 133. The vertical shaft 133 may include a chain, belt or other lifting mechanism to move the mandrel 102 up and down along the vertical shaft 133. There may be a handle 134 or mounting bracket at the top of the vertical shaft to allow lifting of the caddy and/or mounting the caddy to a location. The mandrel 102 can be driven by the motor 129 or a separate, second motor. For example, there may be gears and a clutch system designed to selectively transfer power from the motor 129 to the lifting mechanism of the vertical shaft 133.

Other variations may not use a mandrel 102 or may use an alternative mechanism. In one example, the caddy 108 may be move up and down by itself. For example, when loading storage platters 104, the caddy 108 may elevate above the level of the lubricant in the lubricant tub 106. The storage platters 104 may then be placed in the caddy. After loading the storage platters 104, the caddy may then be lowered into the lubricant tub 106, such that the level of the lubricant fully covers the storage platters 104.

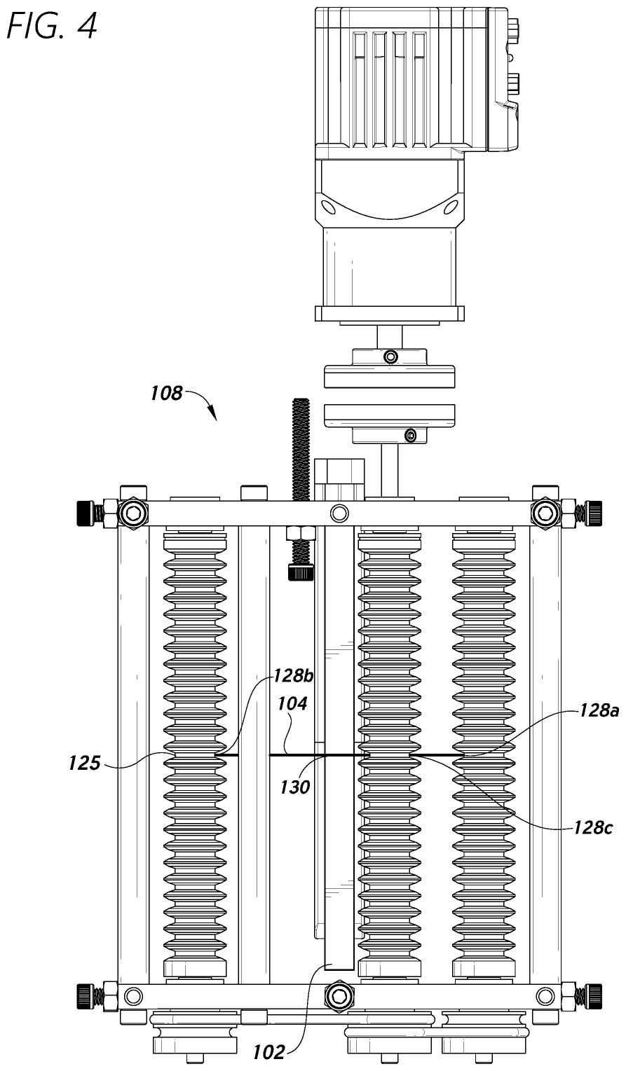

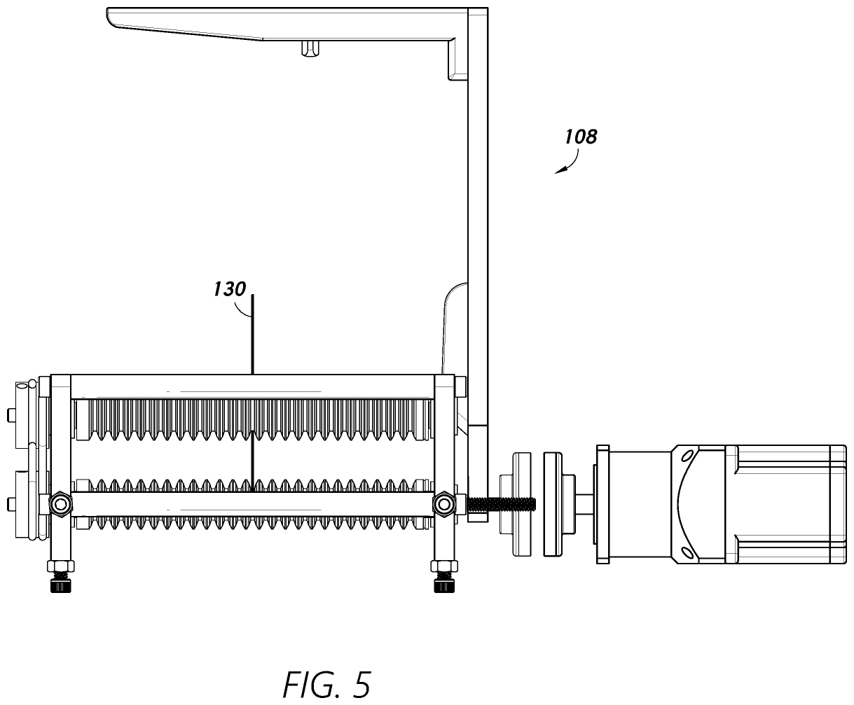

FIGS. 4 and 5 are, respectively, bottom and side views of the caddy 108, in accordance with some embodiments. The grooves 125 that are formed on the rotatable shafts 122 are more easily seen in these views. In the illustrated embodiment, a first storage platter 104 is held in place by grooves 128a, 128b, 128c in each of the rotatable shafts 122a, 122b, 122c, as well as ridges 130 formed on the mandrel 102. The grooves 128a, 128b, 128c and the ridges 130 can be aligned in the same vertical plane to keep the first storage platter 104 upright, for example, at a 90-degree angle relative to the caddy 108. In one example, there are a total of five possible points of contact. However, these contact points may not all be used at once. For example, while lifting or dropping the storage platters 104, the two points of contact at the ridges 130 on the mandrel 102 are likely to be used. When the storage platters 104 are resting in the caddy 108, the three points of contact at the rotatable shafts 122 are likely to be used. As will be apparent, other examples of a caddy can use more or less points of contact to hold the storage platters 104 in place.

In one example, a first platter of the storage disk platters is configured to contact the rotatable shafts at three points of contact, the three points of contact comprising a first groove 128a of the first rotatable shaft, a second groove 128b of the second rotatable shaft, and a third groove 128c of the third rotatable shaft.

In one alternative example, the caddy 108 may only use two rotatable shafts 122a, 122b that are spaced apart narrower than the widest width of the storage platters. The two rotatable shafts are sufficient to hold the storage platters 104 in place. In that example, a first platter of the storage disk platters is configured to contact the rotatable shafts at two points of contact, the two points of contact comprising a first groove of the first rotatable shaft 122a and a second groove of the second rotatable shaft 122b.

### Lubricant Dipping Process

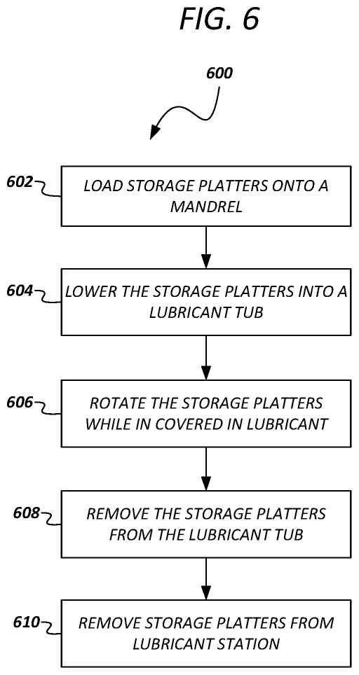

FIG. 6 illustrates a process 600 for dipping storage media into a lubricant bath, in accordance with some embodiments. At least some of the steps of the process 600 may be implemented at least in part by the lubricant station 100 or its components, such as the control circuitry 110 or caddy 108. For ease of explanation, the following refers to components described in FIG. 1. However, the process 600 is not limited to those components and other embodiments of the lubricant station 100 may use different components to run the process.

At block 602, storage platters 104 are loaded onto a mandrel 102. In one example, the mandrel and caddy are sized to fit 25 media disks. Other examples may use different sizes for the mandrel and caddy. Multiple caddies may be used at the same time. For example, 2-6 caddies may be arranged in a group (e.g., 2×1, 2×2, 3×2, 2×3, etc.) in the lubricant tub 106. In some embodiments, there may be tabs, latches, or other attachment mechanisms that enable caddies to be connected together to facilitate using the caddies as a group. Likewise, the mandrel may be extended to hold more storage platters 104. Multiple mandrels may be used. For example, two, three, or even more mandrels may be utilized side-by-side to dip a large number of storage platters 104 into a large lubricant tub 106 that is sized to fit multiple mandrels.

At block 604, the storage platters 104 on the mandrel 102 are lowered into the lubricant tub 106. The storage platters 104 are then placed into the caddy 108. The storage platters 104 are then kept in the bath for the desired amount of time. The dipping may last for several seconds, 20 seconds, 30 seconds, 5 to 25 seconds, a minute, two minutes, etc.

The drop-in speed of the mandrel 102 may be a programmable setting of the lubricant station 100. For example, the drop-in speed may be selected from a range of 1 millimeter (mm)/second (s) to 50 mm/s. In one example, the drop in speed ranges from 15 mm/s-30 mm/s. Faster speeds may also be used. The drop-in speed may be constant or be set to vary. For example, the drop-in speed may start at a faster speed but slow down as the mandrel 102 gets closer to the caddy 108.

At block 606, the rotation mechanism of the caddy 108 is engaged to rotate the storage platters 104 while covered in lubricant in the caddy. In one example, the media disks are rotated 180 degrees to rotate a first side of the media that started on the bottom of the caddy to the top, as discussed above. By rotating the media, the time that different parts of the disk media spend in the lubricant is evened out.

The rotation of the storage platters 104 may be performed in different ways. For example, rotation may be clockwise or counter clockwise. The rotation speed may be a programmable setting of the lubricant station 100. The time of the rotation may be set at different points of the lubrication process. For example, the rotation may be performed right after or soon after placing the storage platters 104 in the caddy 108. Alternatively, the rotation may be performed after the storage platters 104 have been in the lubricant a specified amount of time, right before, or several seconds before removing the storage platter 104 from the lubricant tub 106. For example, the lubricant station 100 may use a timer to countdown the dwell time and may then initiate the rotation a few seconds before the timer ends.

At block 608, the mandrel 102 is lifted to remove the storage platters 104 from the lubricant tub 106. Typically, the mandrel is lifted out slowly, at a speed of around 1 mm per second, to facilitate an even coating of the lubricant. Other speeds may also be used, such as 2 mm per second, 3 mm per second, 4 mm per second, etc. The pull-up speed may be a programmable setting of the lubricant station 100. For example, the pull-up speed may be selected from a range of 1 mm/s to 30 mm/s. The pull-up speed may be constant or be set to vary. For example, the pull-up speed may start at a slower speed but speed up as the mandrel 102 gets further from the caddy 108.

At block 610, the storage platters 104 are removed from the lubricant station 100. The storage platters 104 may be removed by lifting them off from the mandrel 102. For example, a robotic arm or assembly may move the storage platters 104 to a different station for the next step in manufacturing the storage platters 104.

### Additional Embodiments

Those skilled in the art will appreciate that in some embodiments, variations of the caddy 108 and the lubricant station 100 can be implemented while remaining within the scope of the present disclosure. In addition, the actual steps taken in the processes discussed herein may differ from those described or shown in the figures. Depending on the embodiment, certain of the steps described above may be removed, others may be added.

While certain embodiments have been described, these embodiments have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. The accompanying claims and their equivalents are intended to cover such forms or modifications as would fall within the scope and spirit of the protection. For example, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

What is claimed is:

1. A lubricant station for applying lubricant to one or more storage disk platters comprising:
a tub for holding a process fluid comprising lubricant;
a caddy disposed in the tub, the caddy configured to receive the one or more storage disk platters, the caddy comprising:
a mandrel configured to raise and lower the one or more storage disk platters into the tub;
one or more rotatable shafts configured to hold the one or more storage disk platters; and
a drive mechanism for rotating the one or more rotatable shafts; and
control circuitry configured to:
lower, using the mandrel, the one or more storage disk platters onto the one or more rotatable shafts of the caddy;
rotate, using the drive mechanism, the one or more rotatable shafts; and
remove, using the mandrel, the one or more storage disk platters from the tub.

2. The lubricant station of claim 1, wherein the one or more storage disk platters are in a vertical orientation when being raised and lowered into the tub.

3. The lubricant station of claim 2, wherein:
a first platter of the one or more storage disk platters comprises a first edge and a second edge opposite the first edge;
the first edge is positioned at a lowest point of the first platter in the vertical orientation;
the second edge is positioned at a top point of the first platter in the vertical orientation; and
the positions of the first edge and the second edge are reversed after the first platter is lowered into the tub, but before the first platter is removed from the tub.

4. The lubricant station of claim 1, wherein:
a first platter of the one or more storage disk platters comprises a first edge and a second edge opposite the first edge;
the first edge enters the process fluid first, the first edge is rotated to a different position, and the first edge leaves the process fluid first; and
the second edge touches the process fluid last, the second edge is rotated to a previous position of the first edge, and the second edge leaves the process fluid last.

5. The lubricant station of claim 1, wherein the one or more rotatable shafts rotate a first platter of the one or more storage disk platters about 180 degrees while the first platter is submerged in the process fluid.

6. The lubricant station of claim 1, wherein the one or more rotatable shafts rotate a first platter of the one or more storage disk platters about 180+360*n degrees (where n is a whole number) while the first platter is submerged in the process fluid.

7. The lubricant station of claim 1, wherein the one or more rotatable shafts comprise:
a first rotatable shaft with a first plurality of grooves configured to fit edges of one or more storage disk platters; and
a second rotatable shaft with a second plurality of grooves configured to fit the edges of one or more storage disk platters, the second rotatable shaft spaced a distance to a side of the first rotatable shaft, the distance less than a width of a platter of the one or more storage disk platters.

8. The lubricant station of claim 7, wherein the one or more rotatable shafts further comprise:
a third rotatable shaft with a third plurality of grooves configured to fit the edges of one or more storage disk platters, the third rotatable shaft located between and below the first rotatable shaft and the second rotatable shaft.

9. The lubricant station of claim 8, wherein a first platter of the one or more storage disk platters is configured to contact the one or more rotatable shafts at three points of contact, the three points of contact comprising a first groove of the first rotatable shaft, a second groove of the second rotatable shaft, and a third groove of the third rotatable shaft.

10. The lubricant station of claim 7, wherein a first platter of the one or more storage disk platters is configured to contact the one or more rotatable shafts at two points of contact, the two points of contact comprising a first groove of the first rotatable shaft and a second groove of the second rotatable shaft.

11. A caddy device configured to be immersed in a process fluid comprising lubricant, the caddy device comprising:
a mandrel configured to raise and lower one or more storage disk platters;
one or more rotatable shafts configured to hold the one or more storage disk platters; and
a drive mechanism connected to the one or more rotatable shafts and the mandrel;
wherein the drive mechanism is configured to:
lower, using the mandrel, the one or more storage disk platters onto the one or more rotatable shafts;
rotate the one or more storage disk platters on the one or more rotatable shafts; and
remove, using the mandrel, the one or more storage disk platters from the one or more rotatable shafts.

12. The caddy device of claim 11, wherein:
a first platter of the one or more storage disk platters comprises a first edge and a second edge opposite the first edge;
the first edge enters the process fluid first, the first edge is rotated to a different position, and the first edge leaves the process fluid first; and
the second edge touches the process fluid last, the second edge is rotated to a previous position of the first edge, and the second edge leaves the process fluid last.

13. The caddy device of claim 11, wherein:
a first platter of the one or more storage disk platters comprises a first edge and a second edge opposite the first edge;
the first edge is positioned at a lowest point of the first platter with first platter in a vertical orientation;
the second edge is positioned at a top point of the first platter in the vertical orientation; and
the position of the first edge and the second edge are reversed after the first platter is lowered into the process fluid, but before the first platter is removed from the process fluid.

14. The caddy device of claim 11, wherein the one or more rotatable shafts rotate a first platter of the one or more storage disk platters about 180 degrees while the first platter is submerged in the process fluid.

15. The caddy device of claim 11, wherein the one or more rotatable shafts comprise:
a first rotatable shaft with a first plurality of grooves configured to fit edges of one or more storage disk platters; and
a second rotatable shaft with a second plurality of grooves configured to fit the edges of one or more storage disk platters, the second rotatable shaft spaced a distance to a side of the first rotatable shaft, the distance less than a width of a platter of the one or more storage disk platters.

16. The caddy device of claim 15, wherein the one or more rotatable shafts further comprise:
a third rotatable shaft with a third plurality of grooves configured to fit the edges of one or more storage disk platters, the third rotatable shaft located between and below the first rotatable shaft and the second rotatable shaft.

17. A method for rotating storage platters in a lubricant bath, the method comprising:
lowering one or more storage platters onto a rotating mechanism of a caddy, the caddy immersed in the lubricant bath;
rotating, using the rotating mechanism, the one or more storage platters while the one or more storage platters are immersed in the lubricant bath; and
removing the one or more storage platters from the lubricant bath.

18. The method of claim 17, wherein rotating the one or more storage platters comprises rotating the one or more storage platters about 180 degrees.

19. The method of claim 17, wherein rotating the one or more storage platters comprises rotating the one or more storage platters about 180+360*n degrees (where n is a whole number) while the one or more storage platters are submerged in the lubricant bath.

20. A caddy device configured to be immersed in a process fluid comprising lubricant, the caddy device comprising:
lifting means to raise and lower one or more storage disk platters into the process fluid in a lubricant tub;
holding means for holding the one or more storage disk platters; and
driving means for driving the holding means and the lifting means;
wherein the driving means is configured to:
lower, using the lifting means, the one or more storage disk platters onto the holding means;
rotate the one or more storage disk platters on the holding means; and
remove, using the lifting means, the one or more storage disk platters from the process fluid.
